(19) United States
(12) Patent Application Publication
(10) Pub. No.: US 2004/0107528 A1
(43) Pub. Date: Jun. 10, 2004

(54) Vacuum system for a vehicle

(76) Inventors: Douglas D. LeClear, Coloma, MI (US); Carolyn L. Slone, St. Joseph, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 10/648,575

(22) Filed: Aug. 26, 2003

Related U.S. Application Data
(60) Provisional application No. 60/319,502, filed on Aug. 27, 2002.

(51) Int. Cl. B60S 1/64

(52) U.S. Cl. 15/313

(57) ABSTRACT

A vacuum apparatus built-in to a vehicle has a vacuum canister with a vacuum motor. A retractable hose is fluidly connected to the vacuum canister. The hose is selectively retractable and extendable from a motorized reel. Both the vacuum and the reel are operable from a switch on a nozzle at the end of the hose. Cleaning solution from a tank can be selectively sprayed simultaneously with the vacuum operation.

This application claims the benefit of provisional application 60/319,502, filed Aug. 27, 2002.

### BACKGROUND OF INVENTION

1. Field of the Invention

The invention relates to a vacuum cleaner installed in a vehicle. In one aspect, the invention relates to a retractable hose storage device. In another aspect, the invention relates to a wet/dry vacuum cleaner with a combination cleaning solution sprayer and vacuum attachment.

2. Description of the Related Art

Conventional techniques to vacuum the interior of vehicles require the use of exterior household vacuum cleaners and related attachments. Such devices require the cleaning operation to occur in garages, or near homes having convenient sources of electrical power. Vacuuming motor vehicles at commercial carwashes typically utilize exterior stanchions, where a retractable hose is connected to a fixed vacuum unit.

The advent of handheld cordless vacuum cleaners enabled users to carry such portable vacuum cleaner units in a vehicle, untethered to electrical cords, but such units typically do not have the power and suction of a conventional vacuum cleaner, and when power runs low, they must be recharged.

It is known to use portable vacuum cleaners specifically adapted to connect to the vehicle power source, as in U.S. Pat. No. 5,189,753 to Sousa et al. It is also known to use built-in central vacuum cleaning systems in a vehicle as in U.S. Pat. No. 3,449,787 to Rothstein et al., U.S. Pat. No. 5,829,091 to Ingram et al., and U.S. Pat. No. 6,128,804 to Lee et al. Further, U.S. Pat. No. 6,148,472 to Arena suggests the use of a wet/dry vacuum system in a vehicle.

There still remains a problem with effective hose management in the vehicle, as well as problems with effective cleaning. While known vacuum systems can be effective for removal of dirt and debris, stained carpet or upholstery typically requires the use of something more.

### SUMMARY OF INVENTION

These limitations of prior art vacuum cleaning systems in vehicles are overcome by the present invention of a vacuum cleaner for a vehicle having a vacuum canister and a retractable hose fluidly connected to it. The hose is retractable into a storage space in the vehicle. Preferably, the hose is retractable onto a reel stored in the way-back space or trunk of a passenger automobile. In one aspect of the invention, the reel is selectively operable by a switch that actuates a motor to drive the hose off of or onto the reel. Preferably, the vacuum system will have an electrical supply separate from that of the vehicle, or at least selectively separate.

In one aspect of the invention, an apparatus for storing a vacuum hose has a frame and a reel rotatably mounted within the frame for rotation about an axis. The reel has a hub and a vacuum hose has one end mounted to the hub. A roller is fixedly mounted relative to the frame adjacent to the reel in a position to engage the vacuum hose in order to urge the vacuum hose onto and off of the reel when the roller rotates. The frame has a slot extending from the axis toward the roller and the hub moves within the slot, biased toward the roller to keep the vacuum hose engaged with the roller.

In another aspect of the invention, a cleaning system for a vehicle has a vacuum canister fixedly mounted to the vehicle with means for drawing a vacuum in the canister. A hose is fluidly connected to the vacuum canister and a suction nozzle is on the hose. A cleaning solution tank is provided for holding carpet and upholstery cleaning solution and a conduit extends from the cleaning solution tank to a spray nozzle for dispensing cleaning solution from the cleaning solution tank. A control on the suction nozzle controls operation of the vacuum means and the spray nozzle. Preferably, a brush can be located on the suction nozzle to assist in cleaning.

In a further aspect of the invention, sensors are included to determine air quality associated with an occupancy compartment of the vehicle. The sensors can determine when the vacuum canister is full, and can also determine the quality of the exhaust air form the vacuum canister. Preferably, devices can be employed to clean the exhaust air, such as ultraviolet light and photocatalysts. In addition, the exhaust air can be scented to add freshness.

### BRIEF DESCRIPTION OF DRAWINGS

In the drawings:

FIG. 1 is an elevation view, broken away and in section, showing the interior compartment of a vehicle with a vacuum system according to the invention;

FIG. 2 is a perspective view of a portion of a motor vehicle showing a vacuum console according to the invention;

FIG. 3 is a perspective view of the vacuum console of FIG. 1 in the open position;

FIG. 4 is a plan view of a vacuum nozzle according to the invention;

FIG. 5 is an elevational view of the vacuum nozzle of FIG. 4;

FIG. 6 is an elevational view of a vacuum system according to the invention;

FIG. 7 is an elevational view similar to FIG. 6 with the cover to a hose storage module according to the invention removed;

FIG. 8 is a perspective view of a portion of the hose storage module of FIG. 7 showing a portion of the hose retraction system;

FIG. 9 is a cross sectional view taken along lines 9-9 of FIG. 7;

FIG. 10 is a side elevation of the hose storage module of FIG. 7;

FIG. 11 is an elevational view of a vacuum canister according to the invention;

FIG. 12 is a perspective view of the vacuum canister of FIG. 11 in the open position;

FIG. 13 is an elevation view similar to FIG. 6 of an alternative embodiment of a vacuum system according to the invention with a cleaning solution module; and

FIG. 14 is a perspective view of a nozzle for the alternative embodiment shown in FIG. 13.

### DETAILED DESCRIPTION

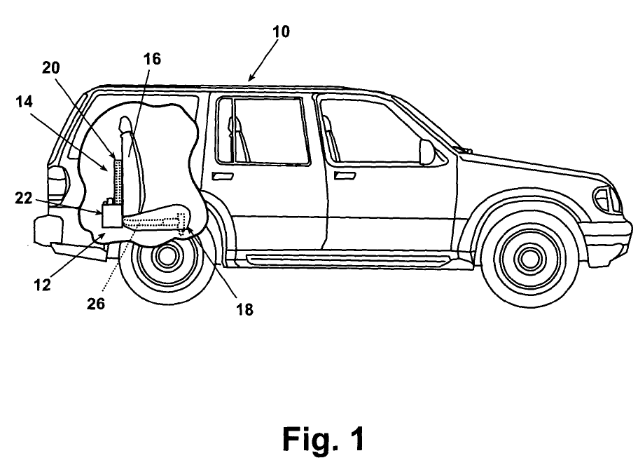

FIG. 1 shows an embodiment of a vehicle 10 having a vacuum system 12 in accordance with an exemplary embodiment of the present invention. The unique design of the vacuum system 12 enables it to be compactly built in to a way back space 14 behind a vehicle seat 16, in the trunk of a passenger automobile, or in virtually any unused portion of the interior of the vehicle. In the exemplary embodiment, the vacuum system 12 comprises a vacuum console 18, a hose storage module 20, and a vacuum canister 22.

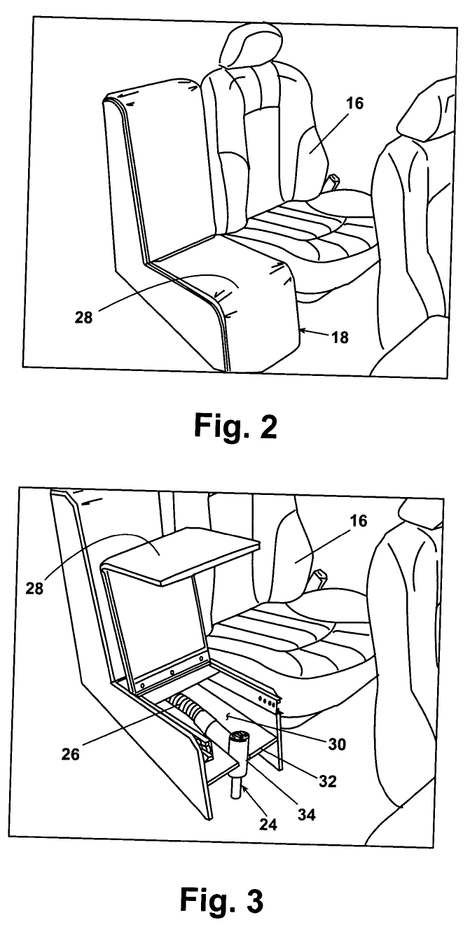

Looking now at FIGS. 2 and 3, the vacuum console 18 may sit adjacent to the vehicle seat 16, and holds a vacuum nozzle 24 attached to the end of a vacuum hose 26. It will be understood that the vacuum console 18 can be apart from a vehicle seat 16 as shown, or it can be integral and indistinguishable from the vehicle seat wherein the vehicle seat itself can serve as the vacuum console. The vacuum console 18 comprises a pivotable and slidable cover 28, here shaped to look like a vehicle seat, and which covers an interior space 30. Within the space is a horizontal panel 32 having an open ended slot 34. The slot 34 is sized to receive and hold the vacuum nozzle 24.

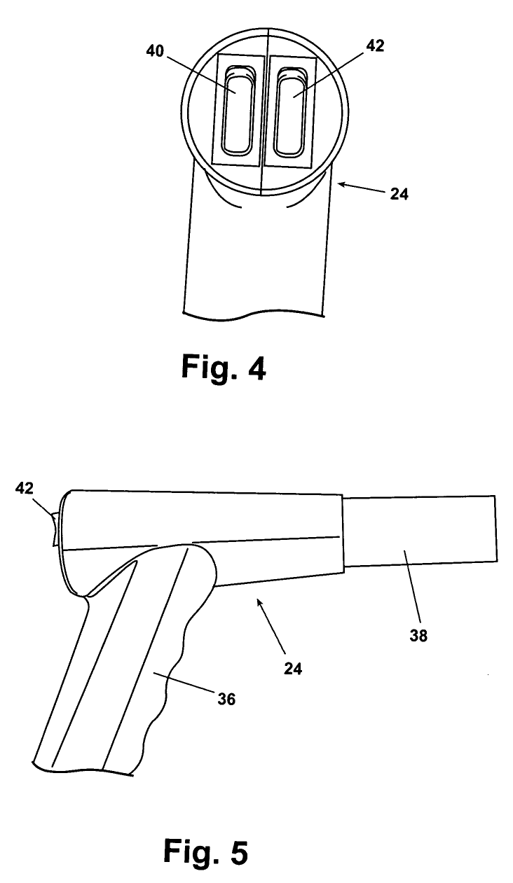

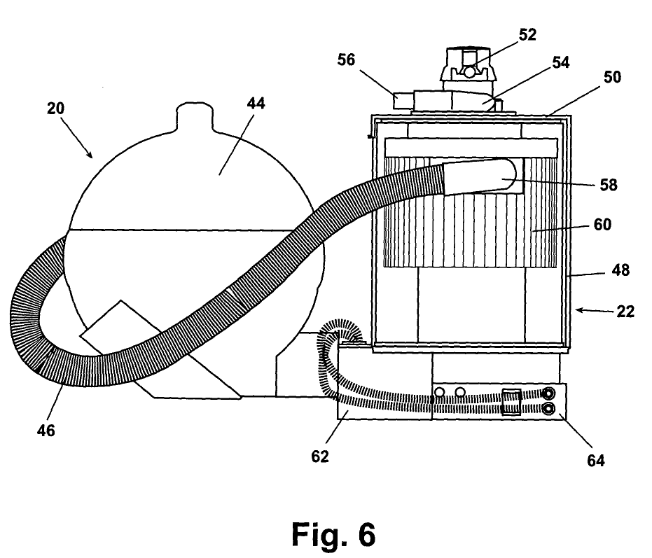

The nozzle 24 is shown in greater detail in FIGS. 4 and 5. It comprises generally a handle portion 36 and a suction spout 38. At a convenient location on the handle portion 36, are two switches 40, 42. One of the switches 40 is electrically connected to the vacuum canister 22 to operate the vacuum, and the other switch 42 is electrically connected to the hose storage module to operate a motorized extension and retraction of the hose 26 as hereinafter described. The hose storage module 20 and the vacuum canister 22 are shown more generally in FIG. 6. The hose storage module is enclosed by a cover 44 and an intermediate vacuum hose 46 extends between the hose storage module 20 and the vacuum canister 22.

The vacuum canister is best shown in FIGS. 6, 11 and 12 and comprises a housing 48 with a pivotable cover 50. Mounted to the cover 50 is a motor 52 and an impeller 54 which, together, will draw a vacuum in the housing 48 when the motor is operating. An exhaust port 56 extends from the impeller 54. An intake port 58 is mounted to the housing 48 and the intermediate vacuum hose 46 is connected to the intake port 58. Inside the housing 48 between the intake port 58 and the impeller 54 is a removable filter 60.

The motor 52 is a conventional 110 volt motor driven by a rechargeable, deep draw battery 62 operatively connected to the 12 volt system of the vehicle. An inverter 64 transforms the voltage for operation of the motor 52. The motor 52 and battery 62 are electrically connected to the vacuum switch 42 on the nozzle 24.

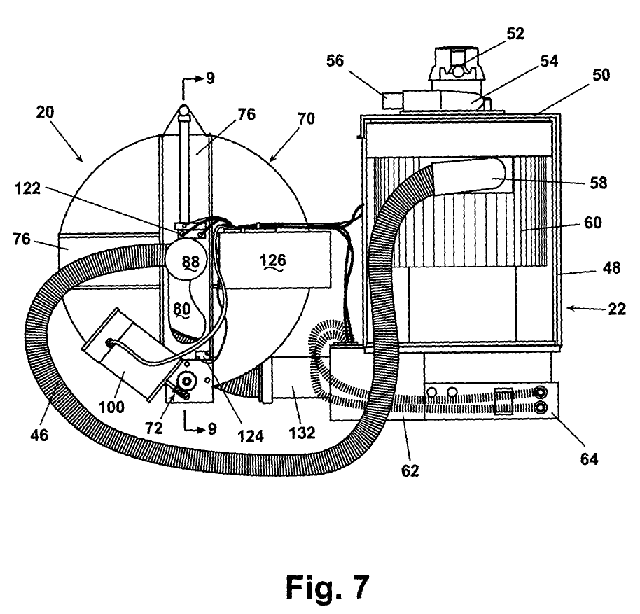

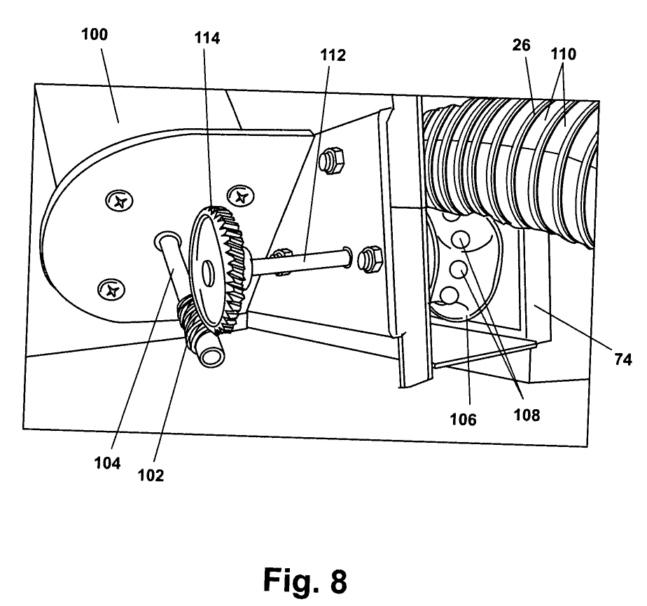

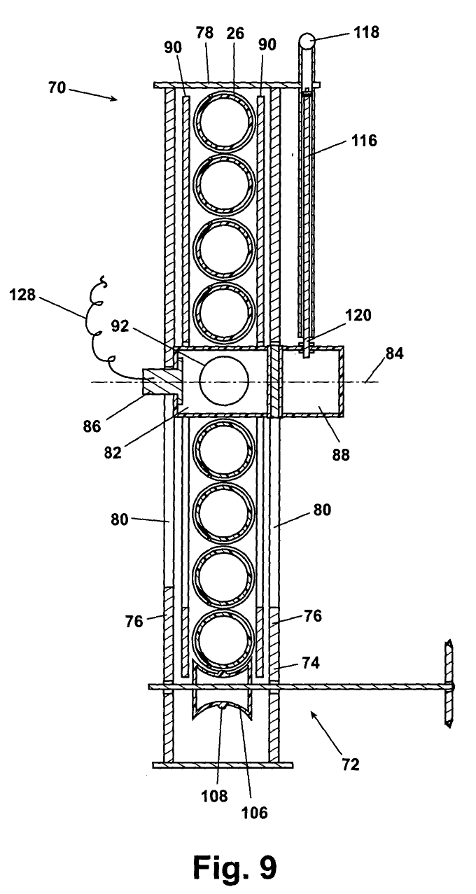

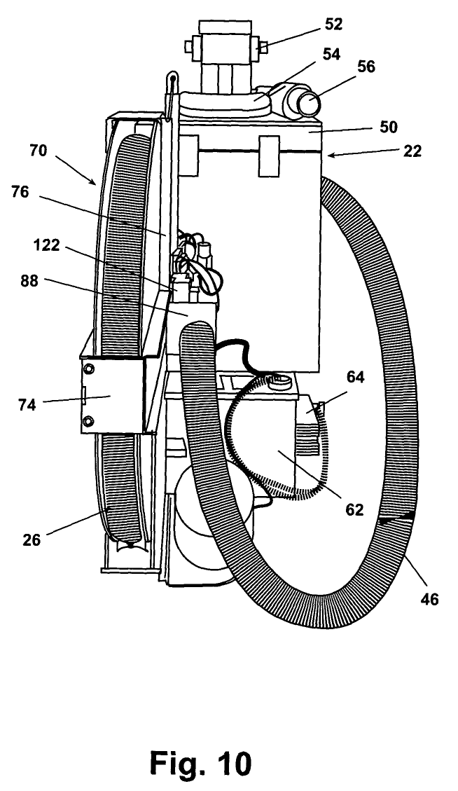

Looking now at FIGS. 7-10, the unique hose storage module 20 according to the invention is shown. The hose storage module 20 comprises generally a reel 70 and a hose retraction device 72 that work together to form a hose retraction and storage system. The reel 70 is best shown in FIGS. 7, 9 and 10 and comprises a fixed frame 74 which is formed of cross members 76 spaced from each other by end brackets 78. One side of the frame 74 is adapted to be mounted to a vertical wall or the back of a seat in a way back space as shown, or to the floor of a trunk in a motor vehicle. One of the vertical members 76 outboard of the supporting surface to which the frame is secured has a slot 80. A hollow hub 82 rotates within the frame at the intersection of the cross members 76 and defines the axis 84 of the rotation of the wheel 70. One end of the hub 82 is closed and mounted to an axle 86 that rides in the vertical slot 80 on the inboard member 76. The other end of the hub 82 communicates with the hollow swivel 88, and is mounted to rotate relative to the swivel 88. The swivel 88 and the hub 82 are permitted to articulate linearly within the slot 80 on the outboard member 76. Opposing circular flat walls 90 are spaced from each other on the hub 82. One end of the retractable hose 26 is secured in fluid communication to the hub 82 at a connection 92. The hose 26 is wrapped spirally around the hub and constrained by the flat walls 90. The intermediate hose 46 is connected in fluid communication to the swivel 88. It will be apparent that the air flow path, when the vacuum is operating, runs from the nozzle 24 through the hose 26, whether or not it is wound on the wheel 70, to the hub 82 and then through the swivel 88 to the intermediate hose 46 to the vacuum housing 48 where it is filtered by the filter 60 and expelled by the impeller 54 through the exhaust 56.

The hose retraction system 72 is best shown in FIGS. 7, 8 and 9. The hose retraction system 72 comprises a drive motor 100 with a worm gear 102 mounted to a shaft 104. A roller, preferably formed rubber, is mounted to the frame 72 adjacent to the house 26 where it is spiraled onto the wheel 70. The roller 106 generally has a concave surface having a radius roughly the same as the radius of the vacuum hose 26. The roller 106 has projections 108 sized and spaced from each other to engage adjacent valleys 110 on one side of the vacuum hose 26. The roller 106 is mounted to a shaft 112 that extends outwardly from the frame 74 to a gear 114 at one end thereof. The gear 114 is disposed to mesh with the worm gear 102. With this configuration, it will be apparent that when the motor 100 is operated in one direction, the hose 26 will be urged by the projections 108 on the roller 106 to move in one direction. Conversely, as the motor 100 is operated in the reverse direction, the hose 26 will also move in the reverse direction.

In order to keep the hose 26 bearing against the roller 106 as it is reeled off of or on to the reel 70, a gas spring 116 has one end 118 mounted to the frame 74 and the other end 120 mounted to the swivel 88. The gas spring is mounted so as to bias the swivel 88 and the hub 82 toward the roller 106.

Preferably, an upper limit switch 122 is mounted at the upper end of the slot 80 and a lower limit switch 124 is mounted near a lower end of the slot 80. The motor 100 is electrically connected to the switch 42 on the nozzle 24. The electrical connections between the retraction drive motor 100 and the switch 42 and the electrical connections between the vacuum motor 52 and the switch 40 are disguised in the hose 26, but it will be apparent that the wiring must accommodate the rotation of the wheel 70.

The electrical wiring is preferably conducted through a control module 126 and the wiring that runs along the hose 26 is connected to the wiring module 126 by a flexible cord 128 similar to a telephone cord which can easily accommodate as many revolutions as necessary to reel and unreel the hose 26 on the reel 70.

Operation of the vacuum system according to the invention is conducted entirely from the nozzle 24. A user will open the console and grasp the nozzle 24. Actuating the switch 42 will energize the drive motor 100 causing the roller 106 to urge the vacuum hose 26 off of the reel 70 through a guide tube 132 and into the console where the user can direct the hose and the nozzle to any location in the vehicle. When the hose 26 is extended to the user's satisfaction, further extension is stopped by turning the switch 42 off. At this time, the user can actuate the switch 40 which energizes the motor 52 to start the vacuum. The user can further extend or retract the hose 26 by actuation of the switch 42 either during or after vacuuming. Dirt will be filtered out by the filter 60 and deposited within the housing 48. When vacuuming is complete, the user can turn the vacuum off with switch 40 and retract the nozzle 24 and the hose 26 back into the console by actuation of the switch 42. As the hose 26 is being extended or retracted, the gas spring 116 continues to bias the hub 82 toward the roller 106 to keep the hose 26 engaged with the roller 106.

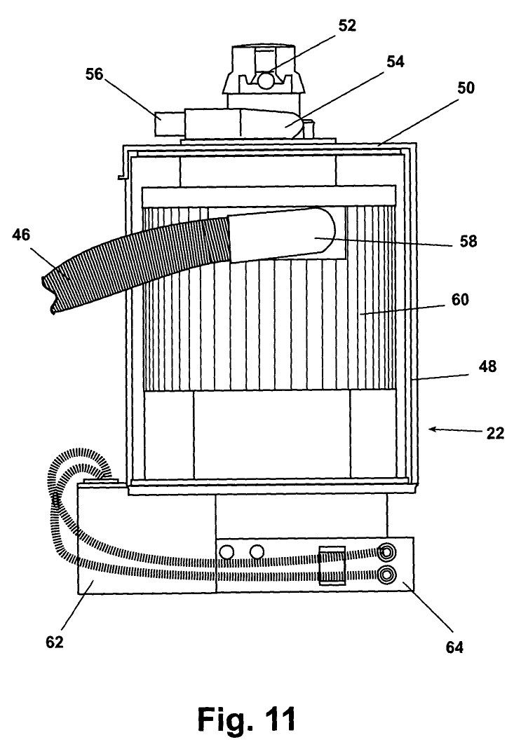

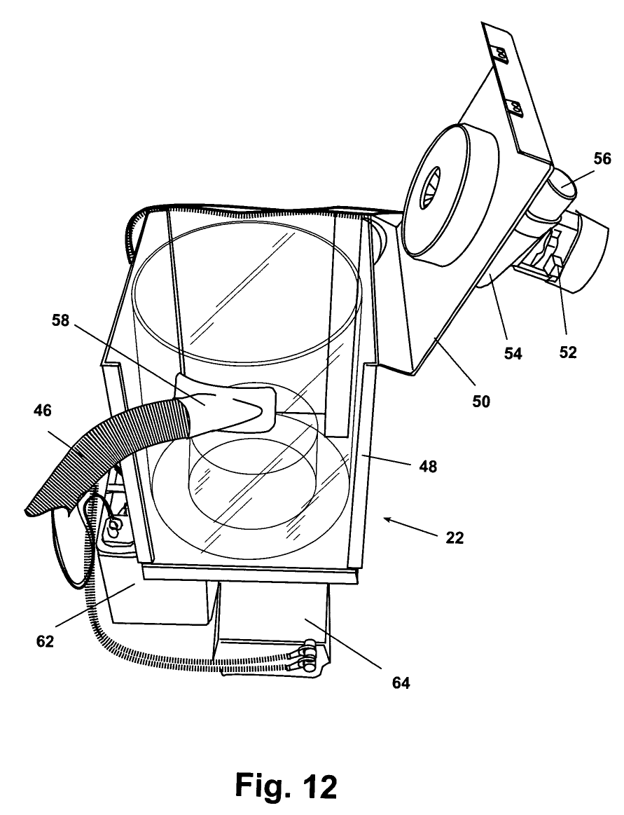

Dirt and debris picked up in the vacuuming process can be removed by opening the cover on the housing 48, removing the filter 60, and emptying the contents of the housing 48 as shown in FIGS. 11 and 12.

Modifications of this embodiment that are clearly within the scope of the invention include utilizing a removable dust bag in the housing 48 within which to entrap dirt and debris from the vacuuming process. It will also be apparent that the intermediate hose 46 can be removed from the intake port 58 and attached to the exhaust port 56 so that the nozzle 24 can be used as a blower instead of a vacuum.

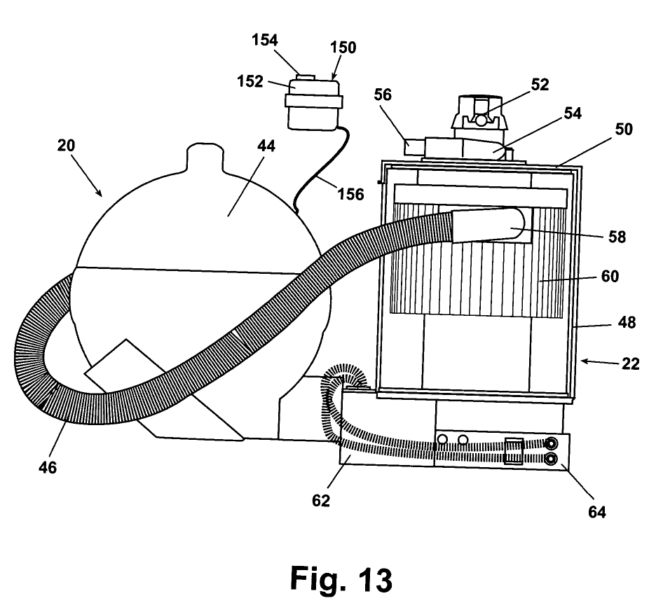

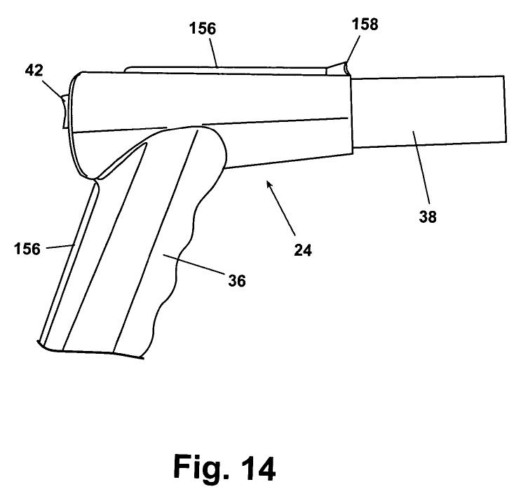

An alternative embodiment of the invention is shown in FIGS. 13 and 14. This embodiment comprises a vacuum system virtually identical to that earlier described, except for the provision of adding cleaning solution to surfaces in the vehicle such as carpet and upholstery. Here a cleaning solution module 150 includes a cleaning solution tank 152 to hold a cleaning solution. The tank 152 has a covered fill opening 154. A conduit 156 extends from the tank to a spray nozzle 158, preferably located on the vacuum nozzle 24. Solution in the tank can be gravity fed to the spray nozzle 158, where it can be sprayed by a manual pump (not shown). Alternatively, the tank 152 and conduit can be pressurized to permit spray from the nozzle 158 upon actuation of a switch (not shown).

While the invention has been specifically described in connection with certain specific embodiments thereof, it is to be understood that this is by way of illustration and not of limitation, and the scope of the appended claims should be construed as broadly as the prior art will permit.

1. A vacuum system for a vehicle comprising:
a hose storage module adapted to house a retractable vacuum hose having a first end and a second end;
a vacuum console adapted to house a vacuum nozzle attached to the first end of the vacuum hose; and
a vacuum canister fluidly connected to the second end of the vacuum hose, the hose storage module being positioned within the vehicle and configured to allow the retractable hose to reach any portion of the interior space of the vehicle.

2. The vacuum system of claim 1, wherein the vacuum console comprises a pivotal and slideable cover in the shape of a vehicle seat.

3. The vacuum system of claim 1, wherein the vacuum console is part of the vehicle seat.

4. The vacuum system of claim 1, wherein the nozzle comprises a handle portion and a suction portion, the handle portion being configured with a first switch being electrically connected to a vacuum motor to operate the vacuum and a second switch being electrically connected to the hose storage module to operate a motorized extension and retraction of the hose.

5. The vacuum system of claim 1, wherein the vacuum canister is driven by a vacuum motor which is rechargeable by a deep draw battery.

6. The vacuum system of claim 1, wherein the hose storage module comprises a reel having a frame being formed from a plurality of cross members and spaced from each other by end brackets, one side of the frame being configured to be mounted to the back of a vehicle seat.

7. The vacuum system of claim 1, wherein the hose storage module comprises a hose retraction system having a roller with a concave surface, the concave surface having a radius roughly the same as that of the vacuum hose.

8. The vacuum system of claim 7, wherein the roller has a plurality of projections sized and spaced from each other to engage a corresponding plurality of adjacent valleys on at least one side of the vacuum hose.

9. The vacuum system of claim 4, wherein the electrical connections are made by electrical wiring that runs along the hose and is connected to a wiring module.

10. The vacuum system of claim 1, further comprising a cleaning solution tank and a conduit extending from the cleaning solution tank to a spray nozzle for dispensing cleaning solution.

11. The vacuum system of claim 10, wherein the nozzle further comprises a control electrically connected to the nozzle for controlling dispensing of the cleaning solution through the spray nozzle.

12. A vacuum system for a vehicle comprising:
a hose storage module having a storage space and adapted to house a retractable vacuum hose on a storage reel;
a vacuum canister fluidly connected to an end of the vacuum hose, and
one or more switches in electrical communication with the hose storage module and configured to extend and retract the hose into and out of the storage space.

13. The vacuum system of claim 12, further comprising a vacuum console adapted to house a vacuum nozzle attached the other end of the vacuum hose; the vacuum console comprising a pivotal and slideable cover in the shape of a vehicle seat.

14. The vacuum system of claim 13, wherein the nozzle comprises a handle portion and a suction portion, the handle portion being configured with a first switch being electrically connected to a vacuum motor to operate the vacuum and a second switch being electrically connected to the hose storage module to operate a motorized extension and retraction of the hose.

15. The vacuum system of claim 12, wherein the hose storage module comprises a hose retraction system having a roller with a concave surface, the concave surface having a radius roughly the same as that of the vacuum hose.

16. The vacuum system of claim 15, wherein the roller has a plurality of projections sized and spaced from each other to engage a corresponding plurality of adjacent valleys on at least one side of the vacuum hose.

17. The vacuum system of claim 12, wherein the storage module further comprises:
a frame;
a hub on the reel and mounted to the frame for rotation about an axis;
a vacuum hose having one end mounted to the hub; and
a roller fixedly mounted relative to the frame adjacent to the reel in a position to engage the vacuum hose in order to urge the vacuum hose onto and off of the reel when the roller rotates;
wherein the frame has a slot extending from the axis toward the roller and the hub moves within the slot, the hub being biased toward the roller to keep the vacuum hose engaged with the roller.

18. The vacuum system of claim 12, further comprising a cleaning solution tank and a conduit extending from the cleaning solution tank to a spray nozzle for dispensing cleaning solution.

19. A cleaning system for a vehicle comprising:
a vacuum canister fixedly mounted to the vehicle and configured to draw a vacuum in the canister;
a hose fluidly connected to the vacuum canister;
a suction nozzle on the hose;
a cleaning solution tank for holding carpet and upholstery cleaning solution;
a conduit extending from the cleaning solution tank to a spray nozzle for dispensing cleaning solution from the cleaning solution tank; and
a control on the suction nozzle to control operation of the vacuum and the spray nozzle.

20. The cleaning system of claim 19, further comprising a storage module having
a frame;
a hub on the reel and mounted to the frame for rotation about an axis;
one end of the vacuum hose being mounted to the hub; and
a roller fixedly mounted relative to the frame adjacent to the reel in a position to engage the vacuum hose in order to urge the vacuum hose onto and off of the reel when the roller rotates.
